(19) United States
(12) Patent Application Publication
(10) Pub. No.: US 2020/0161007 A1
(43) Pub. Date: May 21, 2020

(54) High Yield ICF Target for Large Radiation Gains

(71) Applicants: Eric W. Cornell, Colorado Springs, CO (US); Robert O. Hunter, JR., Aspen, CO (US); David H. Sowle, Santa Maria, CA (US)

(72) Inventors: Eric W. Cornell, Colorado Springs, CO (US); Robert O. Hunter, JR., Aspen, CO (US); David H. Sowle, Santa Maria, CA (US)

(73) Assignee: INNOVEN ENERGY LLC, Colorado Springs, CO (US)

(21) Appl. No.: 15/822,445

(22) Filed: Nov. 27, 2017

Related U.S. Application Data
(60) Provisional application No. 62/497,749, filed on Dec. 1, 2016.

(51) Int. Cl. G21B 1/19; G21C 3/04; G21B 1/03; G21C 3/07

(52) U.S. Cl. CPC G21B 1/19; G21C 3/07; G21B 1/03; G21C 3/048

(57) ABSTRACT

A target assembly for Inertial Confinement Fusion (ICF) achieving a high yield energy output. This high gain target has a low Z fuel/shell region which is lined with a thin layer of a high Z material on the inner surface and then surrounds a low density hotspot region. Adding a thin high Z liner to the inside of the low Z fuel shell has many advantages. As the shell region compresses and heats the central low density hotspot region, the radiation will be contained, and unable to leave the core. This will lower the ignition temperature of target considerably (around a factor of 4). A high Z shell liner may also increase the burn fraction of the fuel as well as increase the areal density (ρr) of the hotspot.

### CROSS-REFERENCE TO RELATED APPLICATION

This application claims priority to U.S. Provisional Application No. 62/497,749 filed on Dec. 1, 2016, and hereby incorporated by reference.

### BACKGROUND

Inertial Confinement Fusion (“ICF”) is a process by which energy is produced by nuclear fusion reactions. The fuel pellet, generally called the target, is conventionally a spherical device which contains fuel for the fusion process. Various ways of driving and imploding the target have been utilized and considered (lasers, ion beams, etc.). These drives transfer energy to the target which then implodes and ignites the fuel. If the fuel is sufficiently heated and compressed, a self-sustaining fusion reaction occurs, wherein the fuel self-heats and produces energy from the fusion reaction.

If the target is to be useful for energy production, it must output more energy than the amount of energy needed to drive the implosion. The amount of energy needed to drive the target may be quite high, as very high temperatures and densities are required to initiate fusion reactions. Also, the amount of energy needed to drive the target must be physically and economically achievable.

The conventional approach to ICF target design is exemplified by the Department of Energy's program, NIF (National Ignition Facility). NIF target designs, as described in Lindl, “The Physics Basis for Ignition Using Indirect Drive Targets on the National Ignition Facility,” Physics of Plasmas, Vol. 11, No. 2, consists of a mostly plastic or beryllium ablator region which surrounds a cryogenic DT ice, and a central void which is filled with very low density DT gas. The target is then placed in a cylindrical hohlraum. The entire target assembly (hohlraum and target) are then placed in the target chamber, where a 192 beamline laser delivers up to 1.8 MJ of energy to the hohlraum. The hohlraum then converts the energy to x-rays which then ablate the ablator region, and by the reactive force drives the DT shell inward.

However, NIF targets have, up to now, never ignited. The areal density (∫₀^{r} dr′ρ(r′) or ρr) of the fuel and the temperature of the fuel has, to date, fallen short of the 0.3 g/cm² and 10 keV they believe they require for ignition. It is not clear why the NIF targets have not achieved ignition, but it may be low order asymmetry of the drive and lower than expected shell velocities.

### SUMMARY

High gain ICF targets and their designs are disclosed which may be more effective at achieving ignition than conventional designs. In some embodiments, these targets may achieve a larger ρr and reduced temperature requirements for ignition. In some embodiments, the fraction of the fuel that is burned may be increased. In some embodiments, the complexity of computational analysis of the target's performance may be decreased.

### DRAWINGS

FIG. 1 shows a cross-section of an embodiment of this invention, an ICF target with a low density hotspot region and a low Z shell with a high Z liner.

FIG. 2 shows a graph of one possible pressure versus time profile on the outside of the low Z shell.

### DESCRIPTION

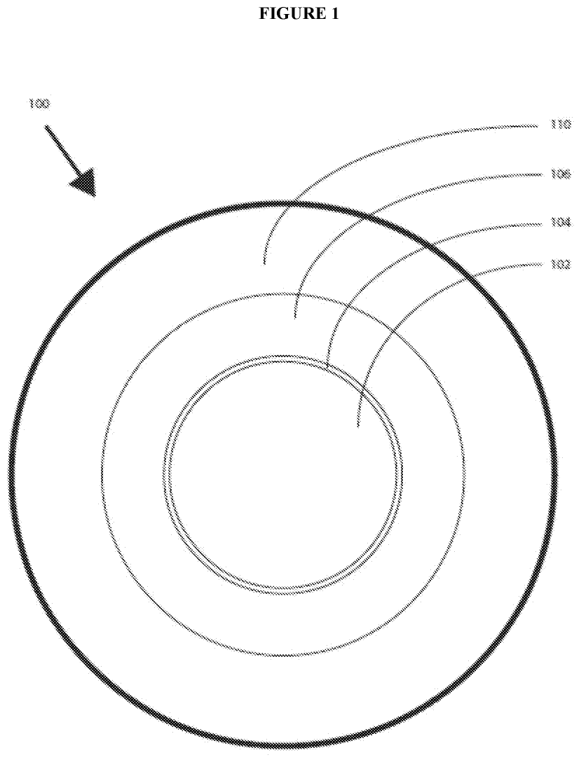

One embodiment, seen in FIG. 1 (not to scale), shows ICF target 100 in which one purpose of the target is to create high gains. For some applications (for example, energy production), it may be desirable to have an output energy much higher than the input energy. It may also be advantageous for that output energy to be in the form of radiation (for example, an energy converter which accepts radiation as its principal input).

This high gain target may have a low Z (where Z is the atomic number of the element, and low refers to elements of Z=1-5) fuel/shell region of DT 106 which is lined (on the interior) with a thin layer of a high Z (where high Z refers to an element of a Z equal to or greater than 48) material 104 like tungsten which surrounds a low density hotspot region 102. The invention discussed herein uses a low Z fuel shell with a high Z liner. Adding a thin high Z liner 104 such as tungsten to the inside of the low Z fuel shell 106 may have many advantages. As the shell 106 compresses and heats the DT gas in the hotspot region 102 of the target 100, the radiation will be contained, and unable to leave the hotspot region 102. This will lower the ignition temperature of target 100 considerably (around a factor of 4). High Z shell liner 104 may also increase the burn fraction of the fuel as well as increase the areal density (ρr) of the hotspot region 102.

This target 100 could be driven directly by laser energy or by converting the laser energy to x-rays in a hohlraum (not shown). One could imagine many ways to drive target 100. One method of drive is ablation of a low or medium Z (where medium refers to elements 6-47) ablator region 110 added to the outside of the DT shell 106. The outside of the ablator region 110 would be ablated by either x-rays from the hohlraum (not shown) or directly by the laser energy, and by the reactive force, drive shell 106 inward. However, shell 106 is driven, it must be driven on a sufficiently low adiabat and quasi-isentropically to prevent premature heating of DT shell 106. The inward motion of shell 106 and the convergence of the shock that shell 106 launches will result in compression and heating of hotspot 102. As hotspot 102 is heated, a thermal wave will go back into high Z liner 104. This thermal heating of liner 104 is the main cooling mechanism of hotspot 102. If the ρr of hotspot 102 is sufficiently large, radiation instead of electron thermal conduction will become the dominant energy loss mechanism of hotspot 102. The high opacity to radiation of tungsten liner 104 lowers the radiative energy loss of hotspot 102 by reflecting a substantial fraction of radiated energy back into hotspot 102. Because of this, ignition of hotspot 102 may occur at a relatively low temperature of about 2.5 keV. Because of the large ρr of the hotspot, acoustic perturbations in the fuel may be smoothed considerably. Therefore, the hotspot will be nearly isothermal and isobaric. Instabilities of the shell/fuel interface due to Richtmeyer-Meshkov (RM) and Rayleigh-Taylor (RT) growth may prevent ignition if shell 106 is not driven with sufficient symmetry. However, these instabilities may be much more easily calculated because of the isobaric nature of the hotspot. Once ignition is reached in hotspot 102, high Z liner 104 will be completely burned through, and burn may propagate from hotspot 102 and ignite DT shell 106, if the ρr of shell 106 is sufficiently large.

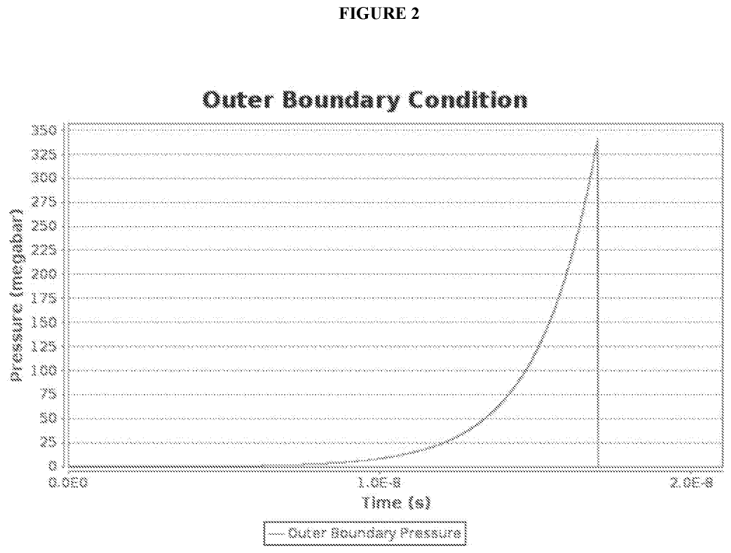

In one embodiment, the outer radius of DT hotspot 102 may be 0.172 cm with a density of 5×10⁻³ g/cc, the thickness of high Z liner 104 may be 10 μm, and the outer radius of DT shell 106 may be 0.196 cm with a density of 0.22 g/cc. No matter the type of drive, whether the drive be ablation of a low Z material by laser energy or x-rays from a hohlraum or any other drive, if a pressure profile similar to the one shown in FIG. 2 is achieved on the outside of shell 106, shell 106 will be driven inward at a velocity of about 4×10⁷ cm/s. As shell 106 is accelerated inwardly, a spherical shock may be launched toward the center of target 100. This shock will move inwardly and heat the fuel. Shell 106 may then compress the heated fuel, and around 17 ns after the initial pressure on the shell 106, hotspot 102 may reach a ρr of about 1.0 g/cm² and a temperature of about 2.5 keV. Under these conditions, the fusion reactions will support and maintain themselves since the a particles will be stopped and deposit their energy in hotspot 102. Hotspot 102 may release about 3 MJ of energy and burn through high Z liner 104. Since DT shell 106 has begun to stagnate, its areal density may be 5 g/cm². Burn may then propagate to DT shell 106. The yield of DT shell 106 may be more than 450 MJ.

One can imagine many variants of this embodiment. Alternative fuels may be used, such as: pure deuterium fuel, lithium deuteride, lithium deuteride with lithium tritide, equimolar deuterium and tritium (DT) or DT with a reduced or increased fraction of tritium, or proton-Boron 11 (p¹¹B), or any other fusion fuel. The initial density of DT hotspot 102 may be increased or decreased. Target 100 may be scaled up or down in size. The radius of hotspot 102 may be increased or decreased. High Z liner 104 may be made of materials other than tungsten, and the thickness of liner 104 may be increased or decreased. Use of high Z materials, or materials with high opacity to radiation in the 0.5-2.5 keV range, may be advantageous, but other materials may be substituted as well. The outer radius of low Z shell 106 may be increased or decreased, and the initial density of shell 106 may be decreased. Specific material choice is still important, where indicated, as different isotopes of the same element undergo completely different nuclear reactions, and different elements may have different radiation opacities for specific frequencies. The differing solid densities of materials with similar Z is also important for certain design criteria.

High Z material in liner 104 may instead be a fissionable material such as uranium-238, although any fissionable material may be used. As the shock produced by the inward movement of the shell heats hotspot 102, prior to runaway burn, some 14 MeV neutrons attempting to leave hotspot 102 will cause fissions within the fissionable material. Some of the neutrons that do not react with the fissionable material may be down-scattered to lower energies by low Z material in shell 106, and these lower energy neutrons may then react with the fissionable material. This may then in turn, heat hotspot 102, and cause ignition earlier in time. Early time ignition is desirable as it leaves less time for RM and RT instabilities to grow.

A decrease in the density of hotspot 102 increases the temperatures achieved during the implosion of hotspot 102, but may also decrease the maximum ρr achieved and increase the temperature required for ignition. An increase in radius of hotspot 102 while maintaining fixed density may improve the maximum ρr, while decreasing peak temperature achieved during the implosion or requiring more drive energy to achieve the same temperature. Reducing the thickness of shell 106 may lead to higher implosion velocities in some embodiments, but may make shell 106 more susceptible to disruption from hydrodynamic instabilities.

Generally speaking, embodiments of this invention may be increased in size by hydrodynamically equivalent scaling (in which all linear dimensions of fuel capsule 100 are multiplied by the same factor). This will increase the ρr achieved in hotspot 102 during the implosion, which may have the effect of lowering the temperature required for ignition of hotspot 102, and in general leading to a more robust implosion and ignition process, at the expense of requiring greater energy to drive the target.

Embodiments of the invention may be reduced in size by the same process. However, as any given embodiment is reduced in size, the ρr achieved in hotspot 102 and DT shell 106 will decrease. As ρr decreases, the mechanism of operation of the embodiment will gradually change, and below a certain threshold, some or all of the advantages described above may be lost and ignition may not occur. For example, as ρr decreases, the temperature required to achieve ignition in hotspot 102 will increase. Radiation damping of perturbations in hotspot 102 will decrease and electron thermal conduction, as opposed to radiation transport, will become the dominant mechanism of energy loss from hotspot 102. Thus, the target will move away from the equilibrium ignition regime, in which the most of the mass of the fuel participates in the fusion reaction, and the ignition of hotspot 102 will become more dependent on the details of hydrodynamic motion and temperature profiles achieved in hotspot 102, and may become more sensitive to perturbations introduced into hotspot 102 by non-uniformity in the target's manufacturing or drive mechanism. At some point as the size of the embodiment is reduced, the implosion velocity and/or uniformity of implosion will be insufficient to achieve ignition of hotspot 102, given the reduced ρr.

Hand calculations and numerical simulations were used in the design of embodiments discussed herein. This design process necessarily involves making approximations and assumptions. The description of the operation and characteristics of the embodiments presented above is intended to be prophetic, and to aid the reader in understanding the various considerations involved in designing embodiments, and is not to be interpreted as an exact description of how embodiments will perform, an exact description of how various modifications will change the characteristics of an embodiment, nor as the result of actual real-world experiments.

Additionally, the set of embodiments discussed in this application is intended to be exemplary only, and not an exhaustive list of all possible variants of the invention. Certain features discussed as part of separate embodiments may be combined into a single embodiment. Additionally, embodiments may make use of various features known in the art but not specified explicitly in this application.

Embodiments can be scaled-up and scaled-down in size, and relative proportions of components within embodiments can be changed as well. The range of values of any parameter (e.g. size, thickness, density, mass, etc.) of any component of an embodiment of this invention, or of entire embodiments, spanned by the exemplary embodiments in this application should not be construed as a limit on the maximum or minimum value of that parameter for other embodiments, unless specifically described as such.

1. A target assembly for Inertial Confinement Fusion (ICF), the target assembly comprising:
a central region, wherein said central region receives a fusion fuel mixture;
a thin liner, surrounding said central region, wherein said thin liner is a material having a Z equal to or greater than 48; and
a shell region, surrounding said thin liner, wherein said shell region receives a fusion fuel mixture having a Z lower than 6;
wherein an outer radius of said central region is about 0.172 cm with a density of about 5×10⁻³ g/cc; a thickness of said thin liner is about 10 μm; and an outer radius of said shell region is about 0.196 cm with a density of about 0.22 g/cc.

2. The target assembly of claim 1, wherein said thin layer comprises a fissionable material.

3. The target assembly of claim 2, wherein the fissionable material comprises U-238.

4. The target assembly of claim 1, wherein said thin liner comprises tungsten.

5. The target assembly of claim 1, wherein the fusion fuel mixture of said shell region comprises any one of the following: pure deuterium fuel, LiD, Li₆DT, DT with a reduced or increased fraction of tritium.

6. (canceled)

7. The target assembly of claim 1, further comprising: adding an ablator region outside of said shell region, wherein said ablator region has a Z lower than 48.

8. A method of extracting an energy yield when imploding a target assembly for Inertial Confinement Fusion (ICF), the method comprising:
constructing a target comprising:
receiving a fusion fuel mixture in a central region;
surrounding said central region with a thin liner, wherein said thin liner comprises a material having a Z equal to or greater than 48;
surrounding said thin liner with a shell region, wherein said shell region receives a fusion fuel mixture having a Z lower than 6;
driving said shell region quasi-isentropically to prevent premature heating of said shell region;
accelerating inwardly said shell region to compress and heat the central region thereby sending a thermal wave back toward said thin liner;
cooling said central region by absorbing the thermal heating in said thin liner; and
extracting an energy yield from said target;
structuring the outer radius of said central region to about 0.172 cm with a density of about 5×10⁻³ g/cc;
structuring the thickness of said thin liner to about 10 μm; and
structuring the outer radius of said shell region to about 0.196 cm with a density of about 0.22 g/cc.

9. The method of claim 8, further comprising: structuring said thin liner with a fissionable material.

10. The method of claim 9, further comprising: structuring said thin liner with U-238.

11. The method of claim 8, further comprising: structuring said thin liner with tungsten.

12. The method of claim 8, further comprising: selecting any one of the following for the fusion fuel mixture of said shell region: pure deuterium fuel, LiD, Li⁶DT, DT with a reduced or increased fraction of tritium.

13. (canceled)

14. The method of claim 8, further comprising:
surrounding said shell region with an ablator region wherein said ablator region has a Z lower than 48; and
driving said target assembly by ablating said ablator region.
